(19) United States
(12) Patent Application Publication
(10) Pub. No.: US 2021/0003532 A1
(43) Pub. Date: Jan. 7, 2021

(54) ULTRASONIC PIPELINE INSPECTION SYSTEM AND METHOD

(71) Applicant: NDT Global Corporate Ltd. Ireland, Dublin 9 (IE)

(72) Inventors: Andy Bain, Dublin (IE); Ibrahim Abu-Aisha, Dublin (IE)

(21) Appl. No.: 16/761,423

(22) PCT Filed: Oct. 26, 2018
(86) PCT No.: PCT/EP2018/079462

§ 371 Date: May 4, 2020

(30) Foreign Application Priority Data
Nov. 6, 2017 (EP) 17200173.7

(51) Int. Cl. G01N 29/04; G01N 29/265; G01N 29/28

(52) U.S. Cl. CPC G01N 29/043; G01N 2291/2636; G01N 29/28; G01N 29/265

(57) ABSTRACT

The invention relates to a system and a corresponding method for the inline inspection of pipelines. A pipeline inspection system according to the present invention comprises an inline inspection tool carrying an ultrasonic transducer system configured to emit ultrasonic energy pulses in response to electrical pulses and convert received ultrasonic energy into electrical signals; control circuitry coupled to the ultrasonic transducer system wherein the control circuitry is configured to control the ultrasonic transducer system and process signals received from the ultrasonic transducer system; and a gelled mass configured to form an elongated body surrounding the inline inspection tool during pipeline inspection.

### TECHNICAL FIELD

The present invention relates to the inspection of pipelines by means of pipeline inline inspection tools.

### BACKGROUND

Pipelines have been used for many years to transport various fluids, such as crude oil, natural gas, and such like. These pipelines are often operated at high pressures and may be exposed to adverse conditions, such as varying ambient temperatures and/or temperatures of the conveyed products, which over time can lead to ruptures or leaks. The detrimental effects of such operation conditions may be compounded by inherent flaws due to faulty weld joints or damage to the pipe during transportation/installation. Pipelines which have been in use for some period of time are also subject to leak or rupture due to corrosion.

So-called inline inspection tools are typically used in the maintenance and inspection of pipelines to perform various operations within a pipeline such as cleaning the pipelines or monitoring the internal surfaces and wall thicknesses. To this end, inline inspection tools are typically inserted into a tool launcher or launch trap. Pressure may then be added that pushes the pipeline inspection tool into and along the pipeline until it reaches a tool receiver where it can be removed from the pipeline. The required pressure may alternatively originate from the fluid (oil, gas, etc.) flowing through the pipeline. Inline inspection tools can therefore be used following product transfer through a pipeline, e.g. at the end of a batch process, or whilst product is flowing through the pipeline in a continuous process.

One form of inline inspection of pipelines using inline inspection tools is based on the application of ultrasonic testing. Whilst this is a practical solution in pipelines through which liquids such as oil or refined products are being transported and where the pipeline medium acts as a reliable couplant for the ultrasonic beam to pass into the pipeline steel, this is not the case for gas pipelines. The lack of a suitable couplant by which the acoustic energy emitted by the ultrasonic transducer is coupled to the pipe wall prevents the ultrasonic testing technique from working in such gas pipelines.

Given that the couplant is whatever fluid the pipeline is transporting and the designer of an inline inspection tool therefore does not have a choice in the couplant, attempts have been made to control and enhance the ability of the ultrasonic transducers to provide closer acoustic impedance matches to the most common pipeline fluids from heavy crude oils to gas. According to EP 0 684 446 A2, for instance, the use of specifically configured, multi-element ultrasonic transducers instead of monolithic piezoelectric transducers is suggested.

It is therefore an object of the present invention to provide an improved system and method of inspection of gas pipelines by means of ultrasonic testing avoiding the aforementioned difficulties and downsides.

### SUMMARY OF EMBODIMENTS OF THE INVENTION

According to a first aspect of the present invention, there is provided a pipeline inspection system comprising: an inline inspection tool carrying an ultrasonic transducer system configured to emit ultrasonic energy pulses in response to electrical pulses and convert received ultrasonic energy into electrical signals; control circuitry coupled to the ultrasonic transducer system wherein the control circuitry is configured to control the ultrasonic transducer system and process signals received from the ultrasonic transducer system; and a gelled mass configured to form an elongated body surrounding the inline inspection tool during pipeline inspection.

The ultrasonic transducer system may comprise at least one individual (monolithic) transducer. Alternatively or in addition, the ultrasonic transducer system may comprise at least one multi-element transducer having a number of small piezoelectric elements arranged in an array such that all elements are electrically driven by the control circuitry.

The gelled mass surrounding the inline inspection tool thereby acts as a homogeneous couplant and allows ultrasound signals to travel from the ultrasonic transducer system to the pipeline wall and back. The present invention is based on the insight that liquid couplants, especially water, are unsuitable for use in gas pipelines. Water, for instance, is a particularly undesirable foreign matter in gas pipelines and especially in pipelines carrying natural gas having a high proportion of methane. It is well known that residual water will form hydrates with the methane under certain conditions which can lead to serious transmission difficulties and unexpected pipeline blockage.

In addition, the gelled mass surrounding the inline inspection tool can provide for a fluid sealing means causing the inline inspection tool to travel through the pipeline by the force of a fluid flowing in the pipeline during inspection. Thus, there is no or at least a reduced need for an inline inspection tool body having a circumferential surface and having fluid sealing means to cause the inline inspection tool body to travel through the pipe by the force of a fluid flowing in the pipe.

What is more, the gelled mass may also effect a cleaning action on the inner sidewalls of the pipeline whilst being pushed through the pipeline.

The gelled mass may further be configured to constitute a self-sustaining body during pipeline inspection having its peripheral surfaces contiguous with the inner surfaces of the inspected pipeline.

The gelled mass may also be configured to conform to a varying inner diameter of the inspected pipeline. Accordingly, the gelled mass is also applicable to dual or multi diameter pipelines.

The gelled mass may comprise a leading portion, a middle portion in which the inline inspection tool is located during pipeline inspection, and a trailing portion, wherein at least one of the leading portion and the trailing portion comprises at least one sealing tool during pipeline inspection. Depending on the properties of the gelled mass and the fluid being transported in the pipeline, it may be necessary to employ sealing tools to protect the gelled mass and/or maintain its integrity/form.

The gelled mass (together with the inline inspection tool) may be configured to fit into the volume of a launcher thereby minimising disruptions and interference in the transport of the fluid in the pipeline to be inspected.

The gelled mass may be a high-viscosity medium having an acoustic impedance substantially matched to the ultrasonic transducer system.

The gelled mass may, during pipeline inspection, provide for a low bypass medium configured to be displaced through the inspected pipeline by a driving fluid behind the gelled mass thereby moving the inline inspection tool through the pipeline.

The system may further comprise a memory device configured to receive and store data representing processed signals from the control circuit as well as an interface configured to transmit the stored data during and/or after pipeline inspection. The interface may operate according to any communication protocol, such as IEEE 802.11, Bluetooth or 3G/4G.

According to a second aspect of the present invention there is provided a method of inspecting a pipeline, preferably a gas pipeline, comprising the following steps: providing an inline inspection tool carrying an ultrasonic transducer system configured to emit ultrasonic energy pulses in response to electrical pulses and convert received ultrasonic energy into electrical signals, wherein the ultrasonic transducer system is coupled to control circuitry being configured to control the ultrasonic transducer system and process signals received from the ultrasonic transducer system; surrounding the inline inspection tool in a gelled mass; and moving the inline inspection tool surrounded by the gelled mass through the pipeline.

Preferably, the steps of providing the inline inspection tool and surrounding the inline inspection tool in a gelled mass are carried out in the volume of a launcher and wherein the inline inspection tool surrounded by the gelled mass is subsequently launched into the pipeline.

The gelled mass may have a leading portion, a middle portion in which the inline inspection tool is located, and a trailing portion, and said method may further comprise the steps of providing at least one sealing tool in the leading portion to seal the gelled mass against a fluid being transported through the pipeline; and/or providing at least one sealing tool in the trailing portion to seal the gelled mass against the fluid being transported through the pipeline.

A third aspect of the present invention relates to the use of a gelled mass as a medium that facilitates the transmission of ultrasonic energy during pipeline inspection. According to this third aspect, the medium is further configured to be used as a material surrounding an inline inspection tool carrying an ultrasonic transducer system during pipeline inspection.

### BRIEF DESCRIPTION OF THE FIGURES

Embodiments of the invention will now be described by way of example only, in which:

FIG. 1 shows a first embodiment of a pipeline inspection system according to the present invention;

FIG. 2 shows a second embodiment of a pipeline inspection system according to the present invention;

FIG. 3 shows a third embodiment of a pipeline inspection system according to the present invention with sealing tools at either end of the system;

FIG. 4 shows a fourth embodiment of a pipeline inspection system according to the present invention with two sealing tools at either end of the system; and

FIG. 5 shows a pipeline inline inspection tool according to the present invention in a tool launcher before its launch into the pipeline;

### DETAILED DESCRIPTION OF EMBODIMENTS OF THE INVENTION

The following description is presented to enable a person skilled in the art to make and use the invention, and is provided in the context of a particular application. Various modifications to the disclosed embodiments will be readily apparent to those skilled in the art. The general principles defined herein may be applied to other embodiments and applications without departing from the scope of the present invention. Thus, the present invention is not intended to be limited to the embodiments shown, but is to be accorded the widest scope consistent with the principles and features disclosed herein.

FIG. 1 shows a first embodiment of a pipeline inspection system 10 according to the present invention. In FIG. 1 the pipeline inspection system 10 is shown inserted into a pipeline 12 to be inspected having a generally circular cross-section.

The pipeline inspection system 10 comprises an inline inspection tool 14 having a first segment 16 and a second segment 18. The inline inspection tool 14 is surrounded by a gel mass 20 which consists of a leading portion 22, a middle portion 24, and a trailing portion 26. The inline inspection tool 14 is arranged in the middle portion 24 with the leading portion 22 ahead and the trailing portion 26 behind it in the direction of flow/movement through the pipeline 12.

On the inline inspection tool 14 there is arranged an ultrasonic transducer system 32 comprising an array of ultrasonic transducers configured to emit ultrasonic energy pulses in response to electrical pulses and convert received ultrasonic energy into electrical signals. The ultrasonic transducer system 32 is operatively coupled to control circuitry (not shown) configured to control the ultrasonic transducer system and process signals received from the ultrasonic transducer system. The inline inspection tool 14 further comprises a memory device (not shown) configured to receive and store data representing processed signals from the control circuit as well as a wired or wireless interface configured to transmit the stored data during or after pipeline inspection.

The pipeline inspection system 10 and thereby the tool 14 is caused to travel through the pipeline 12 by the force of a fluid 30 flowing in the pipeline 12. Due to its high viscosity and with the force of the fluid 30 acting on it, the gelled mass 20 forms an elongated body having its peripheral surfaces contiguous with the inner surfaces of the inspected pipeline. Accordingly, the gelled mass 20 provides for a low bypass medium surrounding the inline inspection tool 14.

Due to the presence of the gelled mass 20, ultrasonic waves can travel between the ultrasonic transducer system 32 and the sidewall of the pipeline 12. Preferably, the acoustic impedance of the gelled mass 20 is closely matched to the one of the ultrasonic transducer system 32.

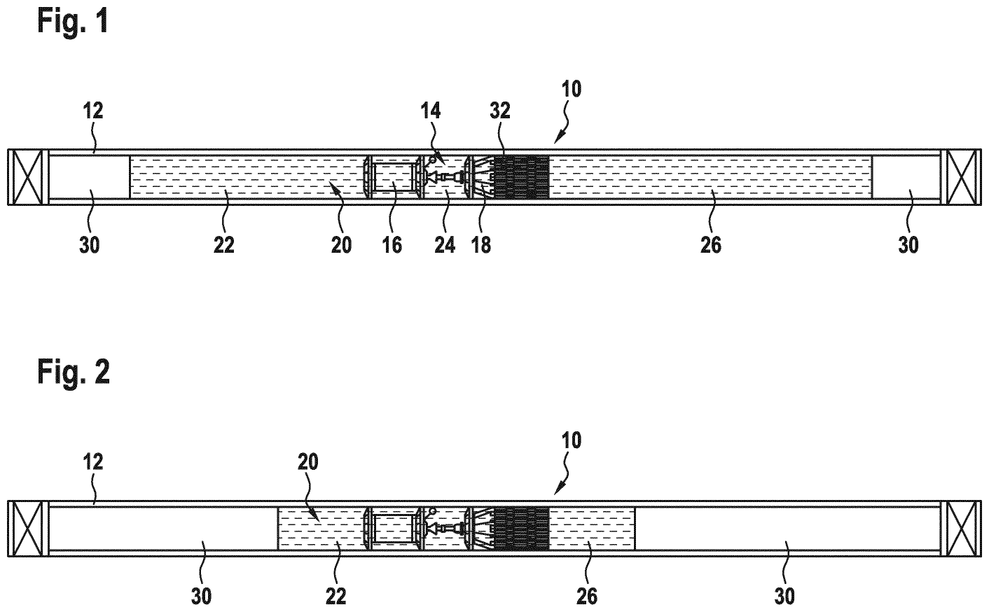

FIG. 2 shows a second embodiment of the present invention. According to this embodiment, the leading portion 22 and the trailing portion 26 of the gelled mass 20 are both of a shorter length compared to those of the first embodiment. Depending on the properties of the gelled mass, this may actually be sufficient to guarantee a safe passage of the pipeline inspection system 10 and specifically the inline inspection tool 14 through the pipeline 12.

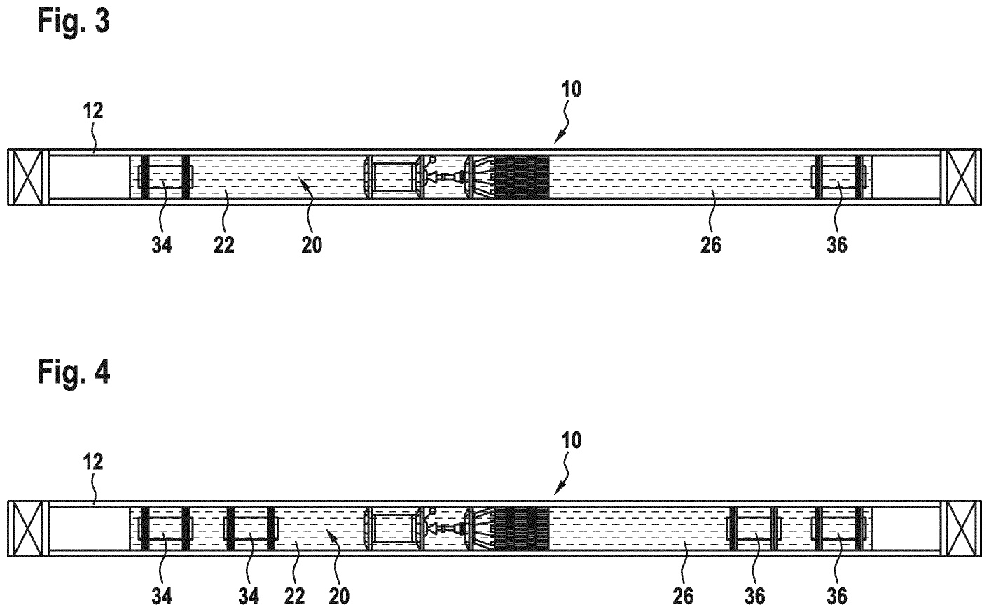

FIGS. 3 and 4 show additional embodiments of the present invention. These embodiments are substantially based on the embodiment according to FIG. 1. In FIGS. 3 and 4, however, sealing tools 34, 36 have been added which help maintain the integrity of the gel batch 10 during inspection and prevent the gel body 20 from being contaminated in the course of the inspection process. As shown in FIG. 3, a first sealing tool 34 is added at the front (i.e., the leading portion 22) of the pipeline inspection system 10 and a second sealing tool 36 is added at the back (i.e., the trailing portion 26). To further enhance the sealing effect, additional sealing tools 34, 36 can be added at the front and/or back of the batch 10, see FIG. 4.

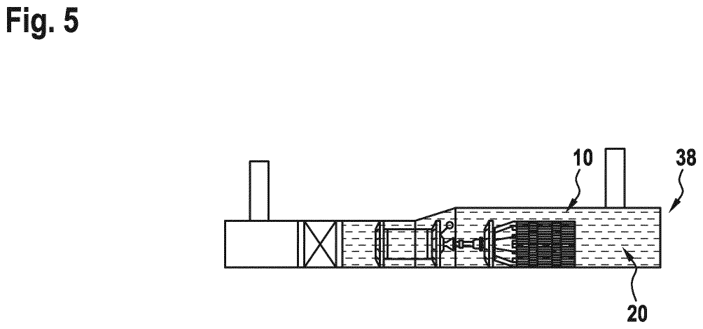

FIG. 5 shows how a pipeline inspection system 10 according to the present invention is inserted into a launcher 38. As shown, the minimum volume of the system 10 is within the volume of a typical launcher 38. This effectively means that the selection of an inline-inspection tool using ultrasonic testing (ILI UT) would have a negligible impact on the pipeline operator. This, in turn, would provide the pipeline operator the full range of the highest accuracy tools for improved asset integrity management.

To ensure that the pipeline inspection system 10 fits within the volume of the inline inspection tool launcher 38, the inline inspection tool 14 is inserted first. Subsequently, the said volume is filled with a suitable fluid followed by a gelling agent/cross-linker causing the gelled mass 20 to form within the volume of the inline inspection tool launcher 38.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A pipeline inspection system comprising:
an inline inspection tool carrying an ultrasonic transducer system configured to emit ultrasonic energy pulses in response to electrical pulses and convert received ultrasonic energy into electrical signals;
control circuitry coupled to the ultrasonic transducer system wherein the control circuitry is configured to control the ultrasonic transducer system and process signals received from the ultrasonic transducer system; and
a gelled mass configured to form an elongated body surrounding the inline inspection tool during pipeline inspection.

2. The system of claim 1, wherein the gelled mass is further configured to constitute a self-sustaining body during pipeline inspection having its peripheral surfaces contiguous with the inner surfaces of the inspected pipeline.

3. The system of claim 1, wherein the gelled mass is configured to conform to a varying inner diameter of the inspected pipeline.

4. The system of claim 1, wherein the gelled mass comprises a leading portion, a middle portion in which the inline inspection tool is located during pipeline inspection, and a trailing portion, wherein at least one of the leading portion and the trailing portion comprises at least one sealing tool during pipeline inspection.

5. The system of claim 1, wherein the gelled mass is configured to fit into the volume of a launcher.

6. The system of claim 1, wherein the gelled mass is a high-viscosity medium having an acoustic impedance substantially matched to the ultrasonic transducer system.

7. The system of claim 1, wherein the gelled mass, during pipeline inspection, provides for a low bypass medium configured to be displaced through the inspected pipeline by a driving fluid behind the gelled mass thereby moving the inline inspection tool through the pipeline.

8. The system of claim 1, further comprising a memory device configured to receive and store data representing processed signals from the control circuit as well as an interface configured to transmit the stored data during and/or after pipeline inspection.

9. A method of inspecting a pipeline comprising the following steps:
providing an inline inspection tool carrying an ultrasonic transducer system configured to emit ultrasonic energy pulses in response to electrical pulses and convert received ultrasonic energy into electrical signals, wherein the ultrasonic transducer system is coupled to control circuitry being configured to control the ultrasonic transducer system and process signals received from the ultrasonic transducer system;
surrounding the inline inspection tool in a gelled mass; and
moving the inline inspection tool surrounded by the gelled mass through the pipeline.

10. The method of claim 9, wherein the steps of providing the inline inspection tool and surrounding the inline inspection tool in a gelled mass are carried out in the volume of a launcher and wherein the inline inspection tool surrounded by the gelled mass is subsequently launched into the pipeline.

11. The method of claim 9, wherein the gelled mass has a leading portion, a middle portion in which the inline inspection tool is located, and a trailing portion, said method further comprising the steps of
providing at least one sealing tool in the leading portion to seal the gelled mass against a fluid being transported through the pipeline; and/or
providing at least one sealing tool in the trailing portion to seal the gelled mass against the fluid being transported through the pipeline.

12. A method comprising:
Use of using a gelled mass as a medium that facilitates the transmission of ultrasonic energy during pipeline inspection and surrounds an inline inspection tool carrying an ultrasonic transducer system during pipeline inspection.
